(19) United States
(12) Patent Application Publication
(10) Pub. No.: US 2012/0239382 A1
(43) Pub. Date: Sep. 20, 2012

(54) RECOMMENDATION METHOD AND RECOMMENDER COMPUTER SYSTEM USING DYNAMIC LANGUAGE MODEL

(75) Inventors: Min-Hsin Shen, Taichung City (TW); Chung-Jen Chiu, Zhubei City (TW); Ching-hsien Lee, Kaohsiung City (TW)

(73) Assignee: INDUSTRIAL TECHNOLOGY RESEARCH INSTITUTE, HSINCHU (TW)

(21) Appl. No.: 13/190,007

(22) Filed: Jul. 25, 2011

(30) Foreign Application Priority Data
Mar. 18, 2011 (TW) 100109425

(51) Int. Cl. G06F 17/27

(52) U.S. Cl. 704/9

(57) ABSTRACT

A recommendation method and a recommender computer system using dynamic language model are provided. The recommender computer system using dynamic language model includes a language model constructing computer module, a language model adapting computer module, a sentence selecting computer module and a sentence recommendation computer module. The language model constructing computer module is used for constructing a language model. The language model adapting computer module is used for dynamically emerging different language models to construct a dynamic language model. The sentence selecting computer module generates a plurality of recommended sentences from a database according to a search keyword. The sentence recommendation computer module analyzes the difference level between the recommended sentences and the dynamic language model and sorts recommended sentences to provide a recommendation list.

This application claims the benefit of Taiwan application Serial No. 100109425, filed Mar. 18, 2011, the subject matter of which is incorporated herein by reference.

### BACKGROUND

1. Technical Field

The disclosure relates in general to a recommender computer system which analyzes the recommendation information generated by a search process according to a dynamic language model, and uses the result to sort the recommendation information.

2. Description of the Related Art

Personalized recommender computer system has been widely used in various marketing models. A user's personal behavior mode can be obtained from the interaction with the user through the personalized recommender computer system, and the personal behavior mode can further be analyzed so that information meeting user's needs can be provided to help the user's decision making. Currently, the recommender computer system is mainly used for analyzing the user's past behavior mode, creating a user profile based on search keyword or key semantics, and searching for the information that may conform to the user's preference.

However, since the conventional search process does not consider whether the recommendation information matches the user's familiar language style or not, it is often seen that the recommendation information cannot meet the user's needs.

### SUMMARY

The disclosure is directed to a recommender computer system which analyzes the recommendation information generated by a search process according to a dynamic language model, and uses the result to sort the recommendation information. The recommender computer system constructs a dynamic language model according to a user's reading course to analyze the user's preferences and familiar language styles so as to provide a personalized recommendation service that meets the user's needs.

According to a first aspect of the present disclosure, a recommendation method using dynamic language model is provided. The recommendation method using dynamic language model includes the following steps. One or a plurality of sentences is provided, wherein the one or a plurality of sentences includes a plurality of words. A plurality of word occurrence probabilities of the one or a plurality of sentences is analyzed. A plurality of word continuation probabilities among the words is analyzed. One or a plurality of language models is constructed according to the word occurrence probabilities and the word continuation probabilities. The one or a plurality of language models is emerged to construct a dynamic language model. A search keyword is provided, and a plurality of recommended sentences are generated by a search process according to the search keyword. The difference level between each of the recommended sentences and the dynamic language model in terms of the word occurrence probabilities and the word continuation probabilities so as to generate a plurality of difference levels. The recommended sentences are sorted according to the difference levels to provide a recommendation list.

According to a second aspect of the present disclosure, a recommender computer system using dynamic language model is provided. The recommender computer system using dynamic language model includes a language model constructing computer module, a language model adapting computer module, a sentence selecting computer module and a sentence recommendation computer module. The language model constructing computer module is used for analyzing a plurality of word occurrence probabilities of a plurality of words of a plurality of one or a plurality of sentences and a plurality of word continuation probabilities among a plurality of words, and constructing one or a plurality of language models according to the word occurrence probabilities and the word continuation probabilities. The language model adapting computer module includes an adapting unit which is used for constructing a dynamic language model according to the one or a plurality of language models. The sentence selecting computer module is used for generating a plurality of recommended sentences from a database containing one or a plurality of sentences by a search process according to a search keyword. The sentence recommendation computer module is used for analyzing the difference level between each of the recommended sentences and the dynamic language model in terms of the word occurrence probabilities and the word continuation probabilities so as to generate a plurality of difference levels, and the recommended sentences are sorted according to the difference levels to provide a recommendation list.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a block diagram of a recommender computer system using dynamic language model according to the present embodiment of the disclosure; and

FIG. 2 shows a flowchart of a recommendation method using dynamic language model according to the present embodiment of the disclosure.

### DETAILED DESCRIPTION

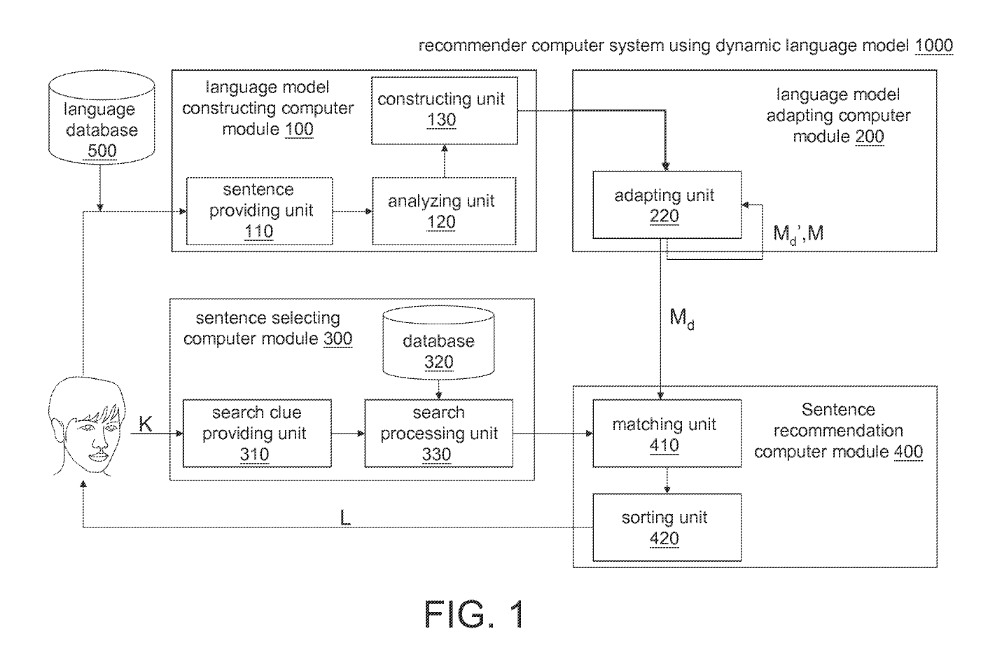

Referring to FIG. 1, a block diagram of a recommender computer system using dynamic language model according to the present embodiment of the disclosure is shown. The recommender computer system using dynamic language model 1000 includes a language model constructing computer module 100, a language model adapting computer module 200, a sentence selecting computer module 300 and a sentence recommendation computer module 400. The language model constructing computer module 100 is used for constructing an initial language model or an adaptive language model M. The language model adapting computer module 200 is used for emerging the initial language model and the adaptive language model M or constructing a dynamic language model M_{d} according to the adaptive language model M, or emerging the previously constructed dynamic language model M_{d}′ and the adaptive language model M to construct an adapted dynamic language model M_{d}. The sentence selecting computer module 300 performs selection according to a search keyword K. The sentence recommendation computer module 400 performs recommendation according to the personalized dynamic language model M_{d} to provide the user with a recommendation list L.

The language model constructing computer module 100 includes a sentence providing unit 110, an analyzing unit 120 and a constructing unit 130. The language model constructing computer module 100 can be realized by a computer, such as a supercomputer, a mainframe computer, a mincomputer, a workstation computer (server), a cloud computing computer or a personal computer. The sentence providing unit 110 is used for providing or inputting various data, and is realized by at least a computer peripheral device, such as a keyboard, a mouse, a connection line for connecting a database or a reception antenna. The analyzing unit 120 is used for performing various data analysis procedures. The constructing unit 130 is used for performing various data model construction procedures. The analyzing unit 120 and the constructing unit 130 are realized by at least an electric element, such as a micro-processor chip, a firmware circuit, and a storage medium storing a plurality of programming codes.

The language model adapting computer module 200 includes an adapting unit 220. The adapting unit 220 is used for performing various data model adapting procedures. The adapting unit 220 is realized by at least an electric element, such as a micro-processor chip, a firmware circuit, and a storage medium storing a plurality of programming codes.

The sentence selecting computer module 300 includes a search clue providing unit 310, a database 320 and a search processing unit 330. The search clue providing unit 310 is used for providing various search clue, and is realized by at least a computer peripheral device, such as a keyboard, a mouse, a connection line for connecting a database or a reception antenna. The database 320 is used for storing various data, and can be realized by at least an electric element, such as a hard disc, a memory or an optical disc. The search processing unit 330 is used for performing various data searching procedures, and can be realized by at least an electric element, such as a micro-processor chip, a firmware circuit, and a storage medium storing a plurality of programming codes.

The sentence recommendation computer module 400 includes a matching unit 410 and a sorting unit 420. The matching unit 410 is used for performing various data matching procedures. The sorting unit 420 is used for performing various data sorting procedures. The matching unit 410 and the sorting unit 420 and can be realized by at least an electric element, such as a micro-processor chip, a firmware circuit, and a storage medium storing a plurality of programming codes.

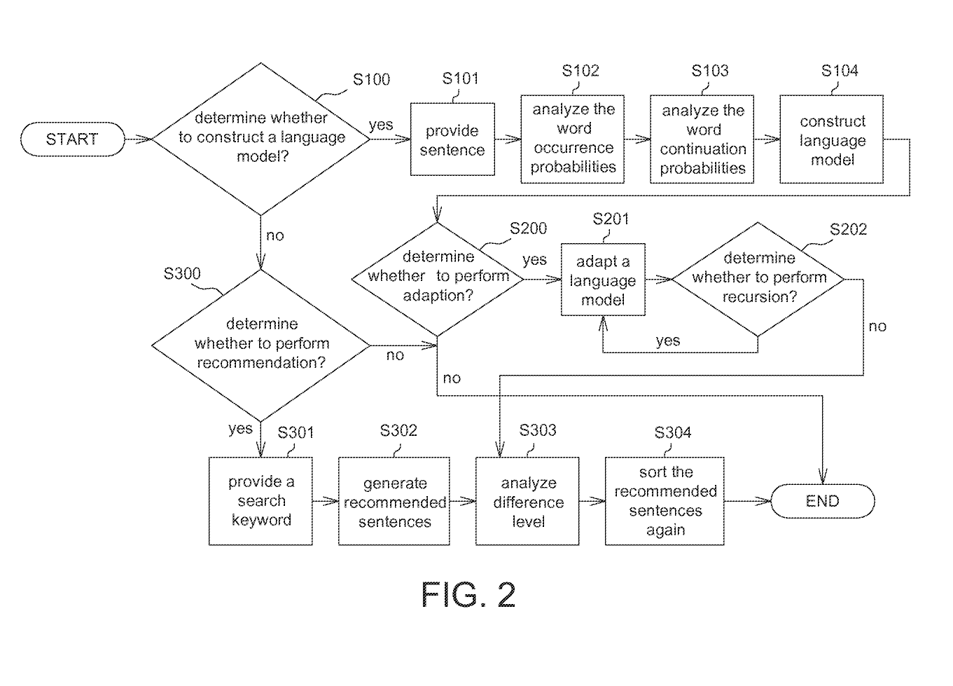

Referring to FIG. 2, a flowchart of a construction method using dynamic language model M_{d} and a recommendation method using dynamic language model M_{d} for sorting recommendation data according to the present embodiment of the disclosure is shown. The details of the construction method using dynamic language model M_{d} and the recommendation method sorting using dynamic language model M_{d} for sorting recommendation data are described below with the exemplification of the recommender computer system using dynamic language model 1000 of FIG. 1. However, anyone who is skilled in the technology of the disclosure will understand that the construction method using dynamic language model M_{d} and the recommendation method using dynamic language model M_{d} for sorting recommendation data disclosed in the present embodiment of the disclosure are not limited to the recommender computer system using dynamic language model 1000 of FIG. 1, and the recommender computer system using dynamic language model 1000 of FIG. 1 is not limited to the application in the flowchart of FIG. 2.

In steps S100 to S104, the method for constructing the adaptive language model M is implemented through the language model constructing computer module 100. Firstly, the method begins at step S100, whether to construct a language model is determined. If it is determined that a language model needs to be constructed, then the method proceeds to step S101; otherwise, the method proceeds to step S300, whether to perform recommendation is determined. In step S101, the sentence providing unit 110 provides one or a plurality of sentences. Each sentence includes a plurality of words. In an embodiment of the present step, the sentence providing unit 110 provides a read book that has been read by a user according to the user's reading course, wherein examples of the read book include “Old Man and Sea”, “Popeye the Sailor Man” and “Harry Potter”. The sentence providing unit 110 fetches sentence according to the content of the read books. The sentence can be a part or a totality of the whole text of each book. The sentence providing unit 110 obtains the information of these books through a user's input, Internet book subscription information, or the book borrowing data of a library.

In another embodiment, sentence providing unit 110 can also provide a subscribed product that a user has subscribed before according to a user subscription course, wherein examples of the subscribed product include computer, bicycle, blue tooth ear phone, DVD player and LCD TV. The sentence providing unit 110 fetches a sentence according to the descriptions of the subscribed product. The sentence can be a part or a totality of the descriptions of the subscribed product. The sentence providing unit 110 provides the subscription course through a user's input, Internet product subscription information or the member data of a retailer.

In an embodiment, apart from constructing an initial language model according to the initial sentence provided by the user, the sentence providing unit 110 can also fetch the sentence related to the background data from the language database 500 according to the user background data to construct the initial language model. For example, after obtaining users' education background, the sentence providing unit 110 can provide related sentence according to the education background.

For example, according to the above method, the sentence providing unit 110 fetches a first sentence: “no, he was being stupid. Potter was not such an unusual name. He was sure there were lots of people called Potter who had a son called Harry”. In the above passage of sentence data, the word count is 28.

In step S102, the analyzing unit 120 analyzes the word occurrence probabilities of the sentence. For example, of the above words, “was” has 3 occurrences, so the word occurrence probability of the word “was” of the above sentence is 3/27. Of the above words, the word “he” has 2 occurrences, so the word occurrence probability of the word “he” of the sentence is 2/27.

The above word occurrence probabilities can be expressed as formula (1) below:

$$P ( {w}_{i} ) = \frac{count ( {w}_{i} )}{N} \qquad ( 1 )$$

Wherein, P(wᵢ) denotes the word occurrence probability; count(wᵢ) denotes the number of occurrence of the word wᵢ; N denotes the total number of words.

In step S103, the analyzing unit 120 analyzes the word continuation probabilities among the words. For example, the word “was” has 3 occurrences, the word combination “was being” has 1 occurrence, so the word continuation probability of the word “being” following the preceding word “was” is ⅓.

The word combination “was being stupid” has 1 occurrence, so the word continuation probability of the word “stupid” following the word combination “was being” is 1.

The above word continuation probabilities can be expressed as formula (2) below:

$$P ( {w}_{i} \vert {w}_{i - ( n - 1 )} , … , {w}_{i - 1} ) = \frac{count ( {w}_{i - ( n - 1 )} , … , {w}_{i - 1} , {w}_{i} )}{count ( {w}_{i - ( n - 1 )} , … , {w}_{i - 1} )} \qquad ( 2 )$$

Wherein, P(wᵢ|wᵢ₋₍ₙ₋₁, . . . , wᵢ₁) denotes the word continuation probability wᵢ following the word combination wᵢ₋₍ₙ₋₁₎, . . . , wᵢ₋₁; count(wᵢ₋₍ₙ₋₁₎, . . . , wᵢ₋₁, wᵢ) denotes the number of occurrence of the word combination wᵢ₋₍ₙ₋₁₎, . . . , wᵢ₁, wᵢ; denotes the number of occurrence of the word combination wᵢ₋₍ₙ₋₁₎, . . . , wᵢ₋₁.

In step S104, the constructing unit 130 constructs an adaptive language model M according to the word occurrence probability and the word continuation probability of these words. In the present step, the constructing unit 130 can perform suitable computation with respect to the word occurrence probabilities and the word continuation probabilities to obtain a suitable index value. For example, the constructing unit 130 can perform logarithmic, exponential and dividing computation with respect to the word occurrence probabilities and the word continuation probabilities of words.

In steps S200 to S202, a dynamic language model M_{d} is constructed by the language model adapting computer module 200 using language model adapting method. Firstly, the method begins at step S200, whether to adapt the dynamic language model M_{d} is determined. If it is determined that the dynamic language model M_{d} needs to be adapted, then the method proceeds to step S201. If it is determined that the dynamic language model M_{d} does not need to be adapted, then the process of constructing the dynamic language model terminates.

In step S201, the adapting unit 220, according to a language model adapting method, emerges the initial language model provided by the language model constructing computer module 100 and the adaptive language model M. In step S202, whether to perform recursion is determined according to the adaptive language model M. If yes, then the adaptive language model M and the previously constructed dynamic language model M_{d}′ are emerged to construct a new dynamic language model M_{d}. For example, when a word does not exist in the previously constructed dynamic language model M_{d}′, the adapting unit 220 can directly add the word occurrence probability of the word of the adaptive language model M to that of the previously constructed dynamic language model M_{d}′, so as to construct a new dynamic language model M_{d}. When the word already exists in the previously constructed dynamic language model M_{d}′ (such as the word “was” as disclosed above), the adapting unit 220 still can perform linear combination according to the following formula (3):

Prₜ₊₁=αPrₜ+βP_{A} (3)

Wherein, Prₜ denotes the index value of the previously constructed dynamic language model M_{d}′; P_{A} denotes the index value of the to-be-added adaptive language model M; Prₜ₋₁ denotes the index value of the adapted dynamic language model M_{d}; α and β are decimal numbers ranging between 0 and 1.

In steps S300 to S304, the recommendation method using dynamic language model M_{d} is implemented through the sentence selecting computer module 300 and the sentence recommendation computer module 400. In step S300, whether to perform recommendation is determined. If it is determined that recommendation needs to be performed, then the method proceeds to step S301; otherwise, the method terminates.

In step S301, the search clue providing unit 310 provides a search keyword K such as a name of a book.

In step S302, the search processing unit 330 generates a plurality of recommended sentences from a database 320 by a search process according to the search keyword K. In the present step, the name of the book and other books related to the search keyword K are generated from the database 320. The content of these books form the recommended sentences.

In step S303, the matching unit 410 analyzes the difference level between the recommended sentences and the dynamic language model M_{d}. The lower the difference between a recommendation sentence and the dynamic language model M_{d}, the higher the frequency of words and the frequency of continuation combinations of words that the recommended sentences and the dynamic language model M_{d} use highly similar words. Therefore, it can be determined that this book is similar to the language style of the sentences ready by the user. For example, each of recommended sentences includes a plurality of words and continuation combinations of words. Through the dynamic language model M_{d}, the difference among the recommended sentences can be obtained. The smaller the difference, the higher the similarity between the book and the dynamic language model M_{d}. The larger the difference, the lower the similarity between the book and dynamic language model M_{d}. The difference value can be applied to the computation of the word occurrence probabilities and the word continuation probabilities to obtain suitable an index value. For example, logarithmic, exponential and dividing computation can be performed with respect to the word occurrence probabilities and the word continuation probabilities.

In step S304, the sorting unit 420 again sorts the recommended sentences according to the difference levels to provide the user with a recommendation list L.

The above embodiment is exemplified by the recommendation of a book. After a dynamic language model M_{d} is constructed according to a user's reading course, the dynamic language model M_{d} can represent the user's preference and familiar language style in reading. For example, the user may prefer books written in literary language or plain language. When the search keyword K provided by a user is a name of a book, several books related to the name of the book are selected first, and then the book conforming to the user's preference and familiar language style can be accurately selected after the matching of the dynamic language model M_{d}.

In an embodiment, the search keyword K provided by the user can be a word or a phrase, and the recommended sentence can be an exemplary sentence or a semantic interpretation thereof. After the search keyword K is provided, related exemplary sentences or semantic interpretations are selected first, and then the exemplary sentence or semantic interpretation conforming to the user's preference and familiar language style can be accurately selected after the matching of the dynamic language model M_{d.}

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A recommendation method using dynamic language model, comprising:
providing one or a plurality of sentences by at least a computer peripheral device, wherein the one or a plurality of sentences comprises a plurality of words;
analyzing a plurality of word occurrence probabilities of the one or a plurality of sentences by at least an electric element;
analyzing a plurality of word continuation probabilities among the words by at least an electric element;
constructing one or a plurality of language models according to the word occurrence probabilities and the word continuation probabilities by at least an electric element;
emerging the one or a plurality of language models to construct a dynamic language model by at least an electric element;
providing a search keyword to generate a plurality of recommended sentences by search process according to the search keyword by at least a computer peripheral device;
analyzing a difference level between each of the recommended sentences and the dynamic language model in terms of the word occurrence probabilities and the word continuation probabilities so as to generate a plurality of difference levels by at least an electric element; and
sorting the recommended sentences according to the difference levels to provide a recommendation list by at least an electric element.

2. The recommendation method using dynamic language model according to claim 1, wherein the search keyword is a name of a book, and the recommended sentences are the content of the book.

3. The recommendation method using dynamic language model according to claim 1, wherein the search keyword is a word or a phrase, the recommended sentences are a plurality of exemplary sentences or a plurality of semantic interpretations of the word or the phrase.

4. The recommendation method using dynamic language model according to claim 1, wherein the step of providing the one or a plurality of sentences comprises:
providing a read book that has been read by a user; and
fetching the one or a plurality of sentences according to the content of the read book.

5. The recommendation method using dynamic language model according to claim 1, wherein the one or a plurality of language models comprises at least an initial language model or one or a plurality of adaptive language models.

6. The recommendation method using dynamic language model according to claim 5, wherein the step of providing the one or a plurality of sentences comprises:
providing a background data of a user; and
providing the one or a plurality of sentences to construct the initial language model according to the background data of the user.

7. The recommendation method using dynamic language model according to claim 5, wherein in the step of constructing the dynamic language models, the one or a plurality of adaptive language models and the previously constructed dynamic language model are merged to update the dynamic language model.

8. A recommender computer system using dynamic language model, comprising:
a language model constructing computer module used for analyzing a plurality of word occurrence probabilities of a plurality of words of one or a plurality of sentences and a plurality of word continuation probabilities among the words, and constructing one or a plurality of language models according to the word occurrence probabilities and the word continuation probabilities by at least an electric element;
a language model adapting computer module comprising an adapting unit for constructing a dynamic language model according to the one or a plurality of language models by at least an electric element;
a sentence selecting computer module used for generating a plurality of recommended sentences from a database containing one or a plurality of sentences by a search process according to a search keyword by at least an electric element; and
a sentence recommendation computer module used for analyzing the difference level between each of the recommended sentences and the dynamic language model in terms of the word occurrence probabilities and the word continuation probabilities so as to generate a plurality of difference levels and sort the recommended sentences according to the difference levels to provide a recommendation list by at least an electric element.

9. The recommender computer system using dynamic language model according to claim 8, wherein the language model constructing computer module, comprises:
a sentence providing unit used for providing the one or a plurality of sentences, wherein the one or a plurality of sentences comprises the words;
an analyzing unit used for analyzing the word occurrence probabilities of the words of the one or a plurality of sentences and analyzing the word continuation probabilities among the words; and
a constructing unit used for constructing the one or a plurality of language models according to the word occurrence probabilities and the word continuation probabilities.

10. The recommender computer system using dynamic language model according to claim 8, wherein the sentence selecting computer module, comprises:
a search clue providing unit used for providing the search keyword;
a database containing the one or a plurality of sentences; and
a searching unit used for generating the recommended sentences from the database by a search process according to the search keyword.

11. The recommender computer system using dynamic language model according to claim 8, wherein the sentence recommendation computer module, comprises:
a matching unit used for analyzing the difference level between each of the recommended sentences and the dynamic language model in terms of the word occurrence probabilities and the word continuation probabilities so as to generate a plurality of difference levels; and
a sorting unit used for sorting the recommended sentences according to the difference levels to provide a recommendation list.

12. The recommender computer system using dynamic language model according to claim 8, wherein the search keyword is a name of a book, and the recommended sentences are the content of the book.

13. The recommender computer system using dynamic language model according to claim 8, wherein the search keyword is a word or a phrase, the recommended sentences are a plurality of exemplary sentences or a plurality of semantic interpretations of the word or the phrase.

14. The recommender computer system using dynamic language model according to claim 9, wherein the sentence providing unit provides a read book that has been read by a user, and fetches the one or a plurality of sentences according to the content of the read book.

15. The recommender computer system using dynamic language model according to claim 8, wherein the one or a plurality of language models comprises at least an initial language model or one or a plurality of adaptive language models.

16. The recommender computer system using dynamic language model according to claim 9, wherein the sentence providing unit provides a background data of a user, and further provides the one or a plurality of sentences to construct the initial language model according to the background data of the user.

17. The recommender computer system using dynamic language model according to claim 8, wherein the adapting unit merges the one or a plurality of adaptive language models and the previously constructed dynamic language model to update the dynamic language model.
